(19) United States
(12) Patent Application Publication
(10) Pub. No.: US 2024/0359582 A1
(43) Pub. Date: Oct. 31, 2024

(54) Charging system including charge restart function of electric vehicle

(71) Applicant: EGTRONICS Co., Ltd., Hwaseong-Si (KR)

(72) Inventors: Chan-Ho Kang, Hwaseong-Si (KR); Young-Gun Hong, Goyang-Si (KR); Ui-Soung Park, Daejeon (KR); Ko Choi, Seoul (KR); Su-Kang Lee, Incheon (KR)

(21) Appl. No.: 18/648,285

(22) Filed: Apr. 26, 2024

(30) Foreign Application Priority Data
Apr. 28, 2023 (KR) 10-2023-0056499

(51) Int. Cl. B60L 53/60; B60L 53/18; H02J 7/00

(52) U.S. Cl. CPC B60L 53/60; B60L 53/18; H02J 7/0047; H02J 7/00711; H02J 7/00712

(57) ABSTRACT

The present disclosure relates to a charging system including a charge restart function of an electric vehicle, including a CP line which is installed on a charger side and is connected to an electric vehicle and charges the electric vehicle by Pulse Width Modulation (PWM) charging method, a sensing unit which is installed on the charger side and senses voltage of the CP line, and a control unit which is installed on the charger side and determines charging environment of the electric vehicle according to sensed voltage of the CP line from the sensing unit, and performs a predetermined number of wake-up sequences on the electric vehicle according to the determined charging environment.

### CROSS-REFERENCE TO RELATED APPLICATION(S)

This application is based on and claims priority of Korean Patent Application No. 10-2023-0056499, filed on Apr. 28, 2023 with the Korean Intellectual Property Office, the entire contents of which are hereby incorporated by reference.

### TECHNICAL FIELD

The present disclosure relates to a charging system including a charge restart function of an electric vehicle, and more particularly, to a charging system configured to automatically restart charging when charging of an electric vehicle is stopped.

### BACKGROUND

In recent years, electric vehicles have gained popularity for environmental reasons. In the early 2010s, technology of electric vehicles was in its early stage, and the performance and travel distance of electric vehicles were not sufficient. However, advances in battery and motor technology have since led to a growing number of electric vehicle models, with performance and travel distance gradually improving.

As electric vehicles become more prevalent, charging infrastructure is also becoming more widespread. Charging of electric vehicles is broadly divided into fast charging and slow charging. In South Korea, slow charging is mainly installed in apartment buildings to charge electric vehicles over a long period of time.

On the other hand, when charging an electric vehicle, charging may be interrupted by either the charger or the electric vehicle itself, depending on whether the connector is properly connected, due to a problem within the electric vehicle, or other factors. When such interruptions occur, users have to recharge their electric vehicles by unplugging and replugging the charger's connector to recharge; this requires the users to constantly monitor the status of the electric vehicles and, if necessary, travel to the electric vehicles to reattach the connector.

### SUMMARY

The present disclosure is designed to solve the technical problems described above, and the object of the charging system including the charge restart function of an electric vehicle according to the present disclosure is to provide a charging system configured to automatically restart charging when charging an electric vehicle.

The charging system including a charge restart function of an electric vehicle according to the present disclosure for solving the aforementioned technical problems may include a control pilot (CP) line which is installed on a charger side and is connected to an electric vehicle and charges the electric vehicle by Pulse Width Modulation (PWM) charging method; a sensing unit which is installed on the charger side and senses voltage of the CP line; and control unit which is installed on the charger side and determines charging environment of the electric vehicle according to sensed voltage of the CP line from the sensing unit, and performs a predetermined number of wake-up sequences on the electric vehicle according to the determined charging environment.

Further, the control unit determines the charging environment as normal if the voltage of the CP line is first voltage.

Further, the control unit determines the charging environment as unstable and requests to repeatedly perform a predetermined number of wake-up sequences to the electric vehicle if the voltage of the CP line is second voltage which is greater than the first voltage.

Further, the control unit requests to repeatedly perform a first number of wake-up sequences to the electric vehicle if a ripple of the second voltage is sensed to be within a first range, wherein the control unit requests to repeatedly perform a second number of wake-up sequences which is greater than the first number to the electric vehicle if the ripple of the second voltage is sensed to be out of the first range.

Further, the control unit determines that a coupler of the charger is not connected to the electric vehicle if the voltage of the CP line is third voltage which is greater than the second voltage.

Further, the sensing unit senses an amount of current flowing to the electric vehicle when charging, wherein if the control unit determines that charging of the electric vehicle has been stopped according to the voltage of the CP line sensed from the sensing unit, the control unit calculates an amount of current that flows to the electric vehicle from a predetermined time before a determination time point to the determination time point, wherein the control unit determines charging of the electric vehicle is completed if the calculated amount of voltage is below a reference value.

Further, the control unit transmits a message indicating completion of charging of the electric vehicle to a predetermined contact if the amount of the current calculated is below a reference value.

Further, the control unit transmits connection status information of the coupler of the charger and the electric vehicle to a predetermined contact if the voltage of the CP line is the third voltage and it is determined that the coupler of the charger and the electric vehicle are not connected.

The charging system including the charge restart function of an electric vehicle according to various embodiments of the present disclosure described above, the control unit determines the current charging environment by sensing voltage of the CP line, and repeatedly requests the wake-up sequence to the electric vehicle via the CP line 100 according to the determined charging environment. As a result, even if charging of the electric vehicle is interrupted by a predetermined reason, charging of the electric vehicle can be resumed without the user having to reconnect the coupler of the charger.

Further, according to the present disclosure, when the control unit determines that the coupler of the charger and the electric vehicle are not connected through voltage sensing of the CP line, information of the current charging status of the electric vehicle is transmitted to a predetermined contact so that the user can take appropriate actions, thereby enabling more efficient operation of the charging system.

### BRIEF DESCRIPTION OF DRAWINGS

FIG. 1 is a schematic diagram of a charging system according to an embodiment of the present disclosure.

FIG. 2 is a flowchart of a charging system according to an embodiment of the present disclosure.

### DETAILED DESCRIPTION OF EXEMPLARY EMBODIMENTS

The object, features, and advantages of the present disclosure will become more apparent with the following embodiments related to the attached drawings. The following specific structural or functional descriptions are exemplified for the purpose of illustrating embodiments in accordance with the concepts of the present disclosure only, and embodiments in accordance with the concepts of the present disclosure may be implemented in various forms and should not be construed as limiting to the embodiments described herein or in the application.

Since the embodiments according to the concepts of the present disclosure are subject to various modifications and may take many forms, certain embodiments are to be illustrated in the drawings and described in detail in the present specification or application. However, this is not intended to limit the embodiments according to the concepts of the present disclosure to any particular disclosed form, and is to be understood to include all modifications, equivalents, or substitutions that fall within the scope of the ideas and techniques of the present disclosure.

Terms such as first and/or second may be used to describe various components, but the components are not limited to the terms. The above terms are used solely for the purpose of distinguishing one component from another, e.g. a first component may be named a second component, and similarly a second component may be named a first component, without departing from the scope of the rights in accordance with the concept of the disclosure.

When a component is referred to as coupled to or connected to another component, it should be understood that it may be directly coupled to or connected to that other component, but there may be other components in between. On the other hand, when a component is said to be directly coupled to or connected to another component, it should be understood that there is no other component in between.

Other expressions to describe the relationship between components, such as between ˜ and directly between ˜ or adjacent to ˜ and directly adjacent to ˜, should be interpreted similarly. The terms used herein is intended to describe particular embodiments only and is not intended to limit the present disclosure.

Singular expressions include plural expressions unless context clearly indicates otherwise. Terms used in the present disclosure such as include or comprise are intended to designate the presence of the features, numbers, steps, operations, components, parts, or combinations thereof described, and are not intended to preclude the presence or addition of one or more other features, numbers, steps, operations, components, parts, or combinations thereof.

Unless otherwise defined, all terms used herein, including technical or scientific terms, have the same meaning as commonly understood by a person of ordinary skill in the technical field to which the present invention belongs. Terms such as those defined in commonly used dictionaries shall be construed to have meanings consistent with their meaning in the context of the relevant art and shall not be construed to have an idealized or unduly formal meaning unless expressly defined in this specification.

Hereinafter, the present disclosure will be described in detail by describing the preferred embodiments of the present disclosure with reference to the attached drawings. The same reference numerals shown in each drawing refer to the same elements.

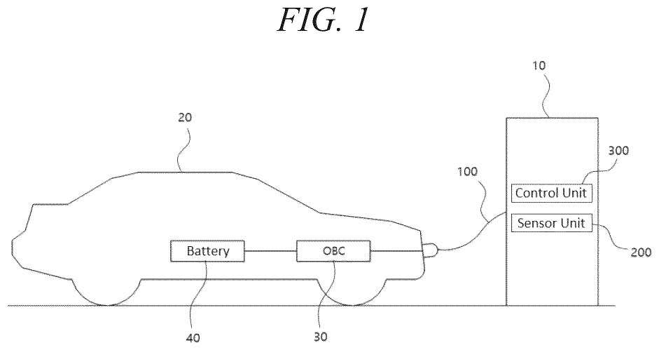

FIG. 1 is a schematic diagram of a charging system according to one embodiment of the present disclosure.

As shown in FIG. 1, the charging system according to one embodiment of the present disclosure may include a charger 10, and a CP line 100, a sensing unit 200, and a control unit 300 installed on the charger 10.

The charger 10 of the charging system according to one embodiment of the present disclosure may be a slow charger, rather than a fast charger. The fast charger may be understood as a charger charging an electric vehicle with an output of 3 to 7 kW.

The CP line 100, which is installed on the charger 10 side, is connected to the electric vehicle 20 and may charge the electric vehicle 20 by Pulse Width Modulation (PWM) charging method. The CP line 100 may be installed on the charger 10, which may also be installed on a connector 11 that connects to the electric vehicle 20. The alternating current of the system input to the charger 10 is input to the electric vehicle 20, and the electric vehicle 20 converts the alternating current input from the charger 10 into direct current through the internally installed On Board Charger 30 (OBC) to charge a battery 40 of the electric vehicle 20.

The sensing unit 200 is installed on the charger 10 side and senses voltage of the CP line 100. Here, the voltage of the CP line 100 refers to the voltage between the CP line 100 and a ground. The sensing unit 200 not only senses the voltage of the CP line 100, but may also sense the amount of current flowing from the charger 10 side to the electric vehicle 20 side. For this purpose, the sensing unit 200 may include a current sensor and a voltage sensor.

The control unit 300 is installed on the charger 10 side and determines the current charging environment of the electric vehicle 20 according to sensed voltage from the sensing unit 200, and performs a predetermined number of wake-up sequences according to the charging environment. The wake-up sequence is a procedure which sends a signal from the charger 10 to the electric vehicle 20 to prepare for charging.

For the operation described above, the control unit 300 may be implemented including a communication module capable of receiving signals and an electronic device capable of generating and applying control signals.

The process of determining the charging environment from the control unit 300 will be explained.

The voltage of the CP line 100 sensed in the sensing unit 200 may vary depending on the charging status. As described above, the charger 10 according to the charging system of the present embodiment charges the electric vehicle 20 through the CP line 100 with the PWM method. When charging the electric vehicle 20 normally in the CP line 100, the voltage of the CP line 100 may be first voltage, and if an error occurs on the electric vehicle 20 side and an internal relay is turned OFF, the voltage of the CP line 100 may be second voltage which is higher than the first voltage. If the connector of the charger 10 and the electric vehicle 20 are not connected, the voltage of the CP line 100 may be third voltage which is higher than the second voltage. For example, the first voltage may be 6V, the second voltage may be between 9V and 12V, and the third voltage may be 12V. However, the present disclosure does not limit the first voltage, the second voltage, and the third voltage to 6V, 9V˜12V, and 12V, respectively, and the first voltage, the second voltage, and the third voltage may be set differently by various factors such as changes in charging conventions or regulations, laws and legislations, and types of the charger 10.

In the description of the present embodiments, when reference is made to a particular voltage being determined, it may be understood to be within the scope of determining that the voltage being determined is equal to or substantially equal to the particular voltage. For example, indicating the voltage of the CP line 100 as the first voltage 6V could mean that the CP line 100 has voltage of exactly 6V, or it could have a value between 5.95V and 6.05V, making it substantially 6V.

The control unit 300 does not perform the wake-up sequence when the voltage of the CP line 100 is the first voltage. If the voltage of CP line 100 is second voltage, the control unit 300 divides the case into two cases and requests wake-up sequences a predetermined number of times to the electric vehicle 20. More specifically, the control unit 300 performs a different number of wake-up sequences depending on the ripple of the voltage of the CP line 100. More specifically, if the ripple of the voltage of the CP line 100 is within a range of 5% with respect to the second voltage, the control unit 300 requests wake-up sequences to the electric vehicle 20 as many times as a first number. If the ripple of the voltage of the CP line 100 is outside of the 5% range with respect to the second voltage, the control unit 300 requests wake-up sequences to the electric vehicle 20 a second number of times which is greater than the first number. For example, the first number may be 3, and the second number may be 30. However, the present invention is not limited to the first number and the second number to 3 and 30, respectively, and the first number and the second number may be varied as needed, but the first number may always be less than the second number. This is to allow the control unit 300 to perform a relatively small number of wake-up sequences repeatedly when the ripple of the voltage of the CP line 100 the 5% range with respect to the second voltage, determining that the charging environment is relatively stable even though charging has stopped, and to perform a relatively large number of wake-up sequences repeatedly when the ripple of the voltage of the CP line 100 exceeds the 5% range of the second voltage, determining that the charging environment is unstable. The ripple range of 5%, where the control unit 300 uses the voltage from the CP line 100 to determine whether the charging environment is in a stable or unstable state, may be varied depending on the need or environment.

The present disclosure has the effect of eliminating the inconvenience of the user manually reconnecting the coupler of the charger 10 to the electric vehicle 20 to resume charging when the charging of the electric vehicle 20 is interrupted for certain reasons through the above procedures.

According to the operation of the control unit 300 described above, determined that charging has stopped when the voltage of the CP line 100 was 9V and 12 V, and a wake-up sequence may be requested to the electric vehicle 20. However, charging will also stop when the electric vehicle 20 is fully charged, in which case the control unit 300 does not need to request a wake-up sequence to the electric vehicle 20. To determine this, the control unit 300 sets a time point as a first time point when the voltage of the CP line 100 changes to 9V and 12V, and calculates the amount of current that flows from the charger 10 to the electric vehicle 20 from a predetermined time before the first time point to the first time point. In the present embodiment, the predetermined time may be 20 minutes, and the control unit 300 may perform a kind of integral calculations to determine the amount of current that flowed from the charger 10 to the electric vehicle 20 from 20 minutes before the first time point to the first time point. The control unit 300 may determine that the charging of the electric vehicle 20 is complete when the amount of calculated current flowed or the amount of current flowed from the charger 10 to the electric vehicle 20 during a reference time is below a predetermined reference value (a value that is almost 0).

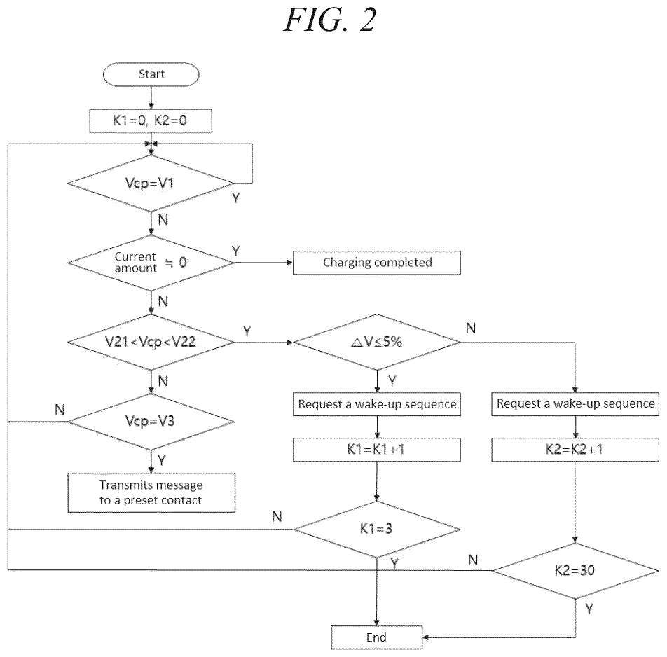

FIG. 2 is a flowchart of a control unit performing a restart function in a charging system according to one embodiment of the present disclosure.

With reference to FIG. 2, cases in which the restart function is performed from the control unit 300 will be described. First, the control unit 300 checks whether Vcp, voltage of the CP line 100 sensed by the sensing unit 200, is first voltage, V1. If the Vcp is equal to the first voltage, the control unit 300 determines that the current charging status is normal and continuously senses the voltage of the CP line 100.

If the Vcp which is the voltage of the CP line 100 sensed by the sensing unit 200, is not the first voltage V1, the control unit 300 determines whether the charging of the electric vehicle 20 is completed by calculating a current amount from a predetermined time before to a comparison time point with regards to the time point at which the voltage of the CP line 100 Vcp and the first voltage was compared, and determines whether the calculated value is close to 0. As a result of the determination, when the amount of current calculated is close to 0, the control unit 300 may determine that charging of the electric vehicle 20 is completed, and transmit a message including charging completion information of the electric vehicle to a predetermined contact or output a message. At this time, the predetermined contact information may be contact information of the user of the electric vehicle 20 or the managing entity of the charging system, and the method of outputting the message may include at least one of visual, tactical, or audio.

The control unit 300 compares the voltage of the CP line 100 Vcp to the second voltage if the current amount calculated is far from 0. The voltage of the CP line 100 Vcp may fluctuate depending on external factors, so the second voltage may have a predetermined range. Therefore, the second voltage may be determined with a lower limit of V21 and an upper limit of V22, and the control unit 300 compares whether Vcp is between V21 and V22. The control unit 300 measures the ripple value of Vcp when Vcp is in the range of the second voltage. The ripple value of the Vcp can be calculated by subtracting the minimum value of the Vcp from the maximum value of the Vcp. The value of subtracting the minimum value of the Vcp from the maximum value of the Vcp is ΔV. If the value of ΔV is within 5% of the average value of Vcp, the control unit 300 requests a wake-up sequence to the electric vehicle 20 and adds 1 to K1 value which was initially set to 0. The K1 is then compared to the first number, i.e., 3. If the K1 has not reached the first number, we may move to the step of comparing Vcp to the first voltage, and repeat the process described earlier.

If the value of ΔV exceeds 5% of the average value of the Vcp, the control unit 300 requests the wake-up sequence from the electric vehicle 20 and adds 1 to K2 value which was initially set to 0. The K2 is then compared to the second number, i.e., 30. If the K2 has not reached the second number, we may move to the step of comparing Vcp to the first voltage, and repeat the process described earlier.

Although not shown in FIG. 2, after the control unit 300 requests the wake-up sequence to the electric vehicle 20 (after the K1 and K2 are added from zero), the K1 and K2 may be initialized to zero if the voltage of the CP line 100 is normally charged in the first voltage.

When the voltage of the CP line 100 Vcp is third voltage V3, the control unit 300 determines that the coupler of the charger 10 is not connected to the electric vehicle 20, and may transmit a message to a predetermined contact. At this time, as described above, the predetermined contact may be the contact information of the user of the electric vehicle 20 or the managing entity of the charging system.

As shown in the flowchart of FIG. 2, the request for the wake-up sequence from the control unit 300 through the CP line 100 to the electric vehicle 20 is not a repeated request within a short period of time, but is performed when certain conditions are met. For example, when the control unit 300 requests a wake-up sequence to the electric vehicle 20, the electric vehicle 20 charges the electric vehicle 20 according to the process of the wake-up sequence. Since this process may take a predetermined amount of time, if the wake-up sequence is requested from the control unit 300 to the electric vehicle 20 shown in FIG. 2, a subsequent process may be performed after a predetermined amount of time (e.g., 20 minutes). This is because the electric vehicle 20 may charge normally according to the wake-up sequence requested from the electric vehicle 20.

The following is a list of embodiments of the present disclosure.

Item 1 is a charging system including a CP line which is installed on a charger side and is connected to an electric vehicle and charges the electric vehicle by Pulse Width Modulation (PWM) charging method; a sensing unit which is installed on the charger side and senses voltage of the CP line; and a control unit which is installed on the charger side and determines charging environment of the electric vehicle according to sensed voltage of the CP line from the sensing unit, and performs a predetermined number of wake-up sequences on the electric vehicle according to the determined charging environment.

Item 2 is the charging system of item 1, wherein the control unit determines the charging environment as normal if the voltage of the CP line is first voltage.

Item 3 is the charging system of any one of items 1 or 2, wherein the control unit determines the charging environment as unstable and requests to repeatedly perform a predetermined number of wake-up sequences to the electric vehicle if the voltage of the CP line is second voltage which is greater than the first voltage.

Item 4 is the charging system of any one of items 1 to 3, wherein the control unit requests to repeatedly perform a first number of wake-up sequences to the electric vehicle if a ripple of the second voltage is sensed to be within a first range, wherein the control unit requests to repeatedly perform a second number of wake-up sequences which is greater than the first number to the electric vehicle if the ripple of the second voltage is sensed to be out of the first range.

Item 5 is a charging system of any one of items 1 to 4, wherein the control unit determines that a coupler of the charger is not connected to the electric vehicle if the voltage of the CP line is third voltage which is greater than the second voltage.

Item 6 is a charging system of any one of items 1 to 5, wherein the sensing unit senses an amount of current flowing to the electric vehicle when charging, and wherein, if the control unit determines that charging of the electric vehicle has been stopped according to the voltage of the CP line sensed from the sensing unit, the control unit calculates an amount of current that flows to the electric vehicle from a predetermined time before a determination time point to the determination time point, wherein the control unit determines charging of the electric vehicle is completed if the calculated amount of voltage is below a reference value.

Item 7 is a charging system of any one of items 1 to 6, wherein the control unit transmits a message indicating completion of charging of the electric vehicle to a predetermined contact if the amount of the current calculated is below a reference value.

Item 8 is the charging system of any one of items 1 to 7, wherein the control unit transmits connection status information of the coupler of the charger and the electric vehicle to a predetermined contact if the voltage of the CP line is the third voltage and it is determined that the coupler of the charger and the electric vehicle are not connected.

While preferred embodiments of the present disclosure have been described above, the embodiments disclosed herein are intended to illustrate and not to limit the technical ideas of the present disclosure. Therefore, the technical idea of the present disclosure includes not only each disclosed embodiment, but also a combination of the disclosed embodiments, and furthermore, the scope of the technical idea of the present disclosure is not limited by these embodiments. Further, those skilled in the art to which the present disclosure belongs may make many changes and modifications to the disclosure without departing from the spirit and scope of the appended claims, and all such appropriate changes and modifications should be considered as equivalents and as falling within the scope of the invention.

What is claimed is:

1. A charging system comprising:
a control pilot (CP) line which is installed on a charger side and is connected to an electric vehicle, wherein the CP line is configured to charge the electric vehicle by Pulse Width Modulation (PWM) charging configuration;
a sensor device installed on the charger side and configured to sense voltage of the CP line; and
a controller installed on the charger side and configured to determine charging environment of the electric vehicle according to sensed voltage of the CP line indicated from the sensor device, wherein the controller is configured to:
perform a predetermined number of wake-up sequences on the electric vehicle according to the determined charging environment;
determine the charging environment as normal if the voltage of the CP line is first voltage,
determine the charging environment as unstable and request to repeatedly perform a predetermined number of wake-up sequences to the electric vehicle if the voltage of the CP line is second voltage which is greater than the first voltage,
request to repeatedly perform a first number of wake-up sequences to the electric vehicle if a ripple of the second voltage is sensed to be within a first range, and
request to repeatedly perform a second number of wake-up sequences which is greater than the first number to the electric vehicle if the ripple of the second voltage is sensed to be out of the first range,
wherein the sensor device is configured to sense an amount of current flowing to the electric vehicle when charging,
wherein, if the controller determines that charging of the electric vehicle has been stopped according to the voltage of the CP line sensed from the sensor device, the controller is configured to determine an amount of current that flows to the electric vehicle from a predetermined time before a determination time point to the determination time point, and
wherein the controller is configured to determine charging of the electric vehicle is completed if the determined amount of voltage is below a reference value and does not request to perform the wake-up sequence to the electric vehicle if charging of the electric vehicle is completed and stopped.

2. The charging system of claim 1, wherein the controller is configured to determine that a coupler of the charger is not connected to the electric vehicle if the voltage of the CP line is third voltage which is greater than the second voltage.

3. The charging system of claim 1, wherein the controller is configured to transmit a message indicating completion of charging of the electric vehicle to a predetermined contact if the amount of the current calculated is below a reference value.

4. The charging system of claim 2, wherein the controller is configured to transmit connection status information of the coupler of the charger and the electric vehicle to a predetermined contact if the voltage of the CP line is the third voltage and it is determined that the coupler of the charger and the electric vehicle are not connected.
